(19) United States
(12) Patent Application Publication
(10) Pub. No.: US 2024/0367352 A1
(43) Pub. Date: Nov. 7, 2024

(54) Plastic Recycling Furnace System "Polymer Processor"

(71) Applicant: Kimberley Renee Coffey, Puyallup, WA (US)

(72) Inventor: Kimberley Renee Coffey, Puyallup, WA (US)

(21) Appl. No.: 18/644,240

(22) Filed: Apr. 24, 2024

Related U.S. Application Data
(60) Provisional application No. 63/500,030, filed on May 4, 2023.

(51) Int. Cl. B29B 17/00; B01D 53/04; B29K 105/26

(52) U.S. Cl. CPC B29B 17/00; B01D 53/0423; B01D 2253/102; B01D 2257/708; B01D 2258/0283; B29K 2105/26

(57) ABSTRACT

A plastic burning furnace system is disclosed. The system can accommodate different plastic waste sizes and is adaptable for both commercial and residential use. The system comprises an upright stainless-steel cylinder with a secure trap door for introducing plastic waste for recycling. A controllable burner initiates melting and burning at the bottom of the cylinder. Smoke resulting from the process is effectively filtered through a series of carbon filters positioned inside the cylinder, and a heat-safe extension cap safely releases the treated fumes into the atmosphere. The molten plastic is poured into color and size-varied disc molds for creating discs for reuse/discardment. The system also includes a smoke meter for providing real-time feedback on smoke levels and a protective boundary for the safety of users.

### CROSS-REFERENCE TO RELATED APPLICATION

The present application claims priority to, and the benefit of, U.S. Provisional Application No. 63/500,030, which was filed on May 4, 2023, and is incorporated herein by reference in its entirety.

### FIELD OF THE INVENTION

The present invention relates generally to the field of plastic recycling systems. More specifically, the present invention relates to a novel plastic burning furnace system for recycling plastic waste into reusable discs while releasing filtered fumes into the atmosphere. The system includes carbon filters for filtering fumes and a series of disc molds for creating reusable discs. A burner is used for melting the plastic waste to pour into the molds. The system helps reduce global warming and reduces plastics in the environment, water, ocean, ground soil, and atmosphere, and increase recycling for people throughout the world. Accordingly, the present disclosure makes specific reference thereto. Nonetheless, it is to be appreciated that aspects of the present invention are also equally applicable to other like applications, devices, and methods of manufacture.

### BACKGROUND

By way of background, plastics are materials that are characterized by their high molecular weight and are composed of various elements such as carbon, hydrogen, oxygen, nitrogen, sulfur, and chlorine. Plastic is formed through polymerization, in which smaller molecular units called monomers link together to form long chains known as polymers. The polymers can be synthetic, derived from petrochemicals, or biopolymers derived from natural sources like plants. In fact, plastics have become an integral part of modern life due to their versatility, durability, and low cost.

United States consumes 525 million tons of garbage plastic of which 5% is recyclable.

However, not all plastics are easily recyclable. Further, most plastics do not biodegrade easily. Such plastics can persist in the environment for hundreds of years, contributing to pollution and ecosystem disruption. Many plastics break down into smaller pieces called microplastics. Microplastics can contaminate soil, water bodies, and even the air, posing threats to wildlife and human health. Many plastics contain chemical additives like plasticizers, flame retardants, and stabilizers. These additives can leach out of plastics and enter the environment, potentially causing harm to both ecosystems and human health.

Plastics can cause health implications including but not limited to endocrine disruptions due to additives such as phthalates and bisphenol. Some plastics contain compounds that are classified as carcinogens or potential carcinogens. Long-term exposure to these substances can increase the risk of cancer in humans. As a result, recycling is important to mitigate the negative environmental and health impacts of plastics. Conventional recycling processes such as burning and processing plastics require significant effort, time, and manual labor and may also cause air and water pollution. People desire an improved and multi-pronged approach to recycle/discard plastic for more responsibility and disposal of plastic.

All industries utilize plastics for packaging: cosmetics, pharmaceuticals, fast food, grocery, healthcare, home products, and more. Ultimately, our consumption heavily outweighs our recycle ability.

Therefore, there exists a long felt need in the art for an improved plastic recycling system. There is also a long felt need in the art for a plastic recycling system that can be used at both commercial and residential level for easy plastic recycling. Additionally, there is a long felt need in the art for a plastic burning device that recycles plastic into small and compact discs for easy recycling. Moreover, there is a long felt need in the art for a recycling system for plastics that filters fumes before releasing smoke into the atmosphere to prevent air pollution. Further, there is a long felt need in the art for a plastic recycling system that provides a deeper burn of the plastic waste and provides a carbon filter system. Furthermore, there is a long felt need in the art for a system for burning toxic waste in an environmentally friendly manner with proper disposal. Finally, there is a long felt need in the art for a polymer burning furnace system that helps reduce global warming and increases recycling of plastic at both the commercial and residential levels.

The subject matter disclosed and claimed herein, in one embodiment thereof, comprises a plastic recycling furnace system. The system comprising an upright stainless-steel cylinder supported by a base, a series of carbon filters positioned along the cylinder, each carbon filter is enclosed in a ceramic shroud, the carbon filters are used for filtering fumes originating from burning of plastic waste, a burner with a control knob attached to the base of the cylinder for melting plastic waste, a trap door to receive the plastic waste, wherein the plastic is completely burned and molten plastic is poured into a series of disc molds, each disc mold has cold walls for solidifying the molten plastic to form discs. The system can be designed in different sizes to recycle/discard plastic at both commercial and residential scales.

In this manner, the polymer recycling system of the present invention accomplishes all of the forgoing objectives and provides users with a plastic burning furnace system for recycling plastics at the commercial and residential level. The system is environmentally friendly as internal carbon filters filter toxic fumes prior to releasing the smoke into the atmosphere. The plastic is recycled into reusable discs of different plastic grades and colors. The system helps reduce global warming and increases recycling for people throughout the world and prevents plastic release into our environment.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plastic burning furnace system for recycling plastic waste into small and compact discs for reuse/discard. The system can be implemented on a commercial or residential level and filters fumes using a series of carbon filters before releasing the fumes into the atmosphere.

In yet another embodiment, a plastic recycling furnace system is disclosed. The system comprising an upright stainless-steel cylinder having a wide base for stability, a trap door disposed in the stainless-steel cylinder for inserting plastic waste, a burner for burning plastic waste at the bottom end of the cylinder, a heat-safe extension cap positioned at a top end of the stainless-steel cylinder to dissipate and safely release fumes from burning plastic waste, a series of carbon filters for filtering fumes before releasing the fumes into the atmosphere, and a series of disc molds for receiving molten plastic and forming plastic waste into discs.

In another aspect of the present invention, a plastic burning furnace system for recycling plastic waste into small and compact discs is disclosed. The system includes an upright stainless-steel cylinder, a series of carbon filters positioned along the cylinder, each carbon filter is enclosed in a ceramic shroud, a burner with a control knob attached to the base of the cylinder for melting plastic waste, a trap door to receive the plastic waste, wherein the plastic is completely burned and molten plastic is poured into a series of disc molds, each disc mold has cold walls for solidifying the molten plastic to form discs. The carbon filters are configured to filter the fumes before releasing the fumes into air. A smoke meter detects smoke pressure within the stainless-steel cylinder and displays the smoke pressure using an analog or manual meter, providing users with information about the combustion process.

In yet another embodiment, a protective boundary constructed from materials including mortar, metal, or steel is used to provide user safety during the plastic burning process.

In still yet another embodiment of the present invention, a method for recycling plastic waste using a plastic burning furnace system is described. The method comprising the steps of inserting plastic waste in the form of solid blocks used in conjunction with a compacting device for plastic of varying sizes through a trap door provided on an upright stainless-steel cylinder of the plastic burning furnace system, wherein the trap door is operable to be locked and unlocked, activating a burner within the stainless-steel cylinder through user interaction and controlling the burner using a control knob to initiate the burning and melting of the inserted plastic waste, filtering fumes produced during burning of the plastic waste using carbon filters positioned along the stainless-steel cylinder, and releasing the filtered fumes from a heat-safe extension cap located at a top end of the stainless-steel cylinder, and pouring the molten plastic resulting from the burning process into a series of disc molds and enabling the molten plastic to solidify within the disc molds, thereby converting the molten plastic into a series of recycled discs.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a polymer burning furnace system of the present in accordance with the disclosed architecture;

FIG. 2 illustrates an internal view of the cylinder of the plastic recycling system in accordance with the disclosed structure;

FIG. 3 illustrates an enlarged view of the disc molds used in the plastic recycling system of the present invention for forming recycled discs in accordance with the disclosed structure; and

FIG. 4 illustrates a flow chart depicting the recycling process of plastic waste using the plastic recycling furnace device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved plastic recycling system. There is also a long felt need in the art for a plastic recycling system that can be used at both commercial and residential level for easy plastic recycling. Additionally, there is a long felt need in the art for plastic burning device that recycles plastic into small and compact discs for easy recycling. Moreover, there is a long felt need in the art for a recycling system for plastics that filters fumes before releasing smoke into the atmosphere to prevent air pollution. Further, there is a long felt need in the art for a plastic recycling system that provides a deeper burn of the plastic waste and provides a carbon filter system. Furthermore, there is a long felt need in the art for a system for burning toxic waste in an environmentally friendly manner with proper disposal. Finally, there is a long felt need in the art for a polymer burning furnace system that helps reduce global warming and increases recycling of plastic at both commercial and residential level.

The present invention, in one exemplary embodiment, is a method for recycling plastic waste in an environmentally friendly manner. The method comprising the steps of inserting plastic waste in the form of solid blocks of pre compacted by plastic compactor into mold/pellet 10″×12″ through a trap door provided on an upright stainless-steel cylinder of the plastic burning furnace system, wherein the trap door is operable to be locked and unlocked, activating a burner within the stainless-steel cylinder through user interaction and controlling the burner using a control knob to initiate the burning and melting of the inserted plastic waste, filtering fumes produced during burning of the plastic waste using carbon filters positioned along the stainless-steel cylinder, and releasing the filtered fumes from a heat-safe extension cap located at a top end of the stainless-steel cylinder, and pouring the molten plastic resulting from the burning process into a series of disc molds and enabling the molten plastic to solidify within the disc molds, thereby converting the molten plastic into a series of recycled discs.

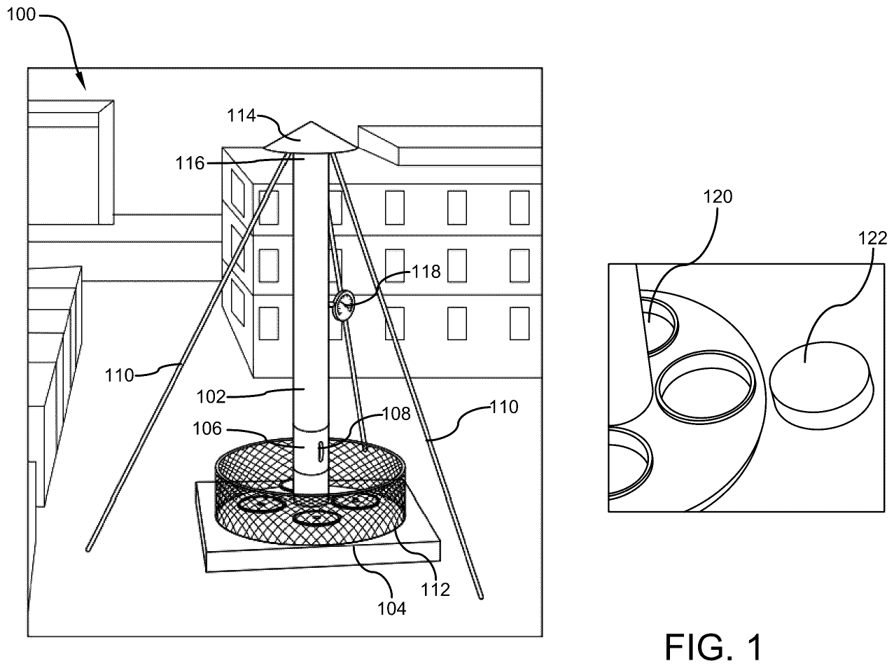

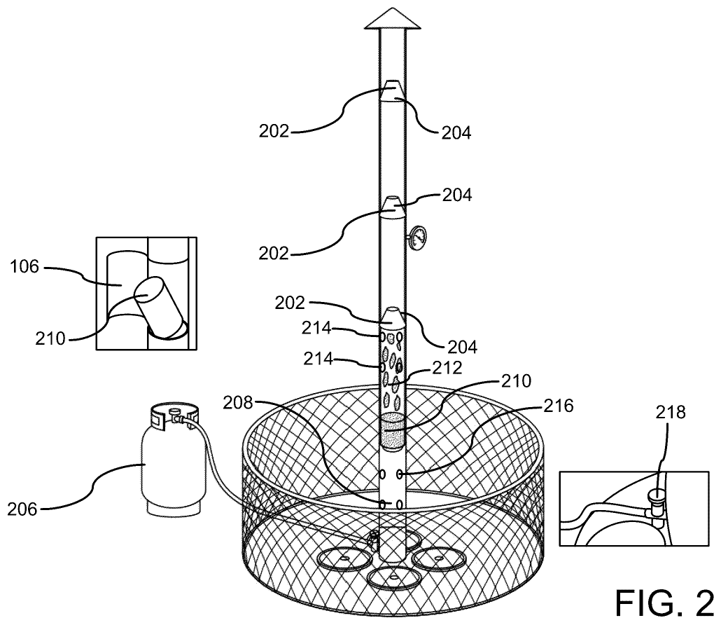

Referring initially to the drawings, FIG. 1 illustrates a perspective view of one potential embodiment of the polymer burning furnace system of the present in accordance with the disclosed architecture. The plastic burning furnace system 100 is designed as a system for burning plastic and recycling into small and compact discs for reuse. The system 100 can be designed in different sizes to meet the requirements of commercial and residential plastic recycling. More specifically, the system 100 includes an upright stainless-steel cylinder 102 having a wide base 104 for providing a strong base to the cylinder 102. The stainless-steel cylinder 102 includes a trap door 106 for enabling a user to insert precompressed plastic items such as solid plastic blocks for recycling. The trap door 106 can be locked and unlocked using a handle 108 positioned on the trap door 106 and the cylinder 102 includes a burner at the bottom end thereof for burning plastic as illustrated in FIG. 2.

The cylinder 102 is also supported using a series of supporting members 110 to prevent the cylinder 102 from tilting or falling in strong winds. The supporting members 110 can be made of wire or metal and can be anchored into the ground. A protective boundary 112 to safeguard users from potential contact with high temperatures or fumes is included in the system 100 wherein the boundary 112 can be made of mortar, metal, steel, or any other durable and strong material. A heat-safe extension cap 114 is positioned at the top end 116 of the cylinder 102. The heat-safe extension cap 114 dissipates the smoke of burning plastic, enabling the smoke to exit into the atmosphere safely without posing a danger to users.

The cylinder 102 provides a passage for smoke towards the heat-safe extension cap 114 and a smoke meter 118 is coupled to the cylinder 102 for detecting smoke level inside the cylinder 102. The smoke meter 118 provides visual identification and can also provide an visual alert to users about the smoke level inside the cylinder 102. More specifically, the smoke meter 118 detects the pressure of the smoke inside the cylinder 102 and has an analog or manual meter for displaying the smoke pressure. The polymer burning furnace device 100 recycles the plastic received through the trap door 106 into discs 122 that are formed in a series of disc molds 120. The disc molds 120 can be of different sizes and have different colors therein for enabling discs of different based on residential/commercial use.

FIG. 2 illustrates an internal view of the cylinder 102 of the plastic recycling system 100 in accordance with the disclosed structure. The cylinder 102 includes a series of carbon filters 202 positioned, preferably equidistantly along the stem of the cylinder 102. Each carbon filter 202 includes a ceramic shroud 204 which provides heat resistance and durability to the carbon filter 202. Each filter 202 is highly porous and has a large surface area that can adsorb various carbons substances, including volatile organic compounds (VOCs), gases, and other pollutants from the fumes passing therethrough. It will be apparent to a person skilled in the art that the ceramic shroud provides thermal insulation to each filter 202 thereby preventing same from overheating or becoming damaged due to the high temperatures generated during the burning process of plastic.

A burner 206 is connected to the base 208 of the steel cylinder 102 and is configured to provide heat for burning of the plastic 210 inserted through the trap door 106. Upon controlled burning of the plastic 210 using the burner 206, the plastic 210 melts and releases fumes 212. The fumes 212 are guided through the evaporation ports 214 into the carbon filter system 202, where harmful components are adsorbed and neutralized. The filtered fumes are exhausted into the environment through the heat-safe extension cap 114, thereby, not deteriorating the atmosphere and not causing air pollution unlike conventional plastic recycling systems.

The base 208 of the steel cylinder 102 includes a set of moisture vents 216 for enabling a more thorough burn of the plastic waste 210. The moisture vents 216 facilitate the escape of moisture and steam generated during the plastic burning process, helping in the formation of solid plastic discs. Upon burning, the molten plastic 210 is automatically poured into the disc-shaped molds 120. The molds 120 are designed to allow for the melted plastic to solidify into discs, which can then be sorted and recycled/discarded based on color and size.

In different embodiments of the present invention, the burner 206 can be one of a propane burner, a natural gas burner, an electric heating element, or any other conventional burner. Further, the burner 206 can be activated and deactivated using a control knob 218 to activate/deactivate burning of plastic. The temperature maintained in the base 208 for burning of the plastic can be configured depending on the plastic and can range from about 600° C. to about 1100° C. for complete combustion and breakdown of plastic into simpler molecules like carbon dioxide and water vapor.

The device 100 provides a controlled incineration method with pollution control while treating harmful byproducts before they are released into the atmosphere. The device 100 can be designed in different sizes and can be used for recycling of different types of plastics.

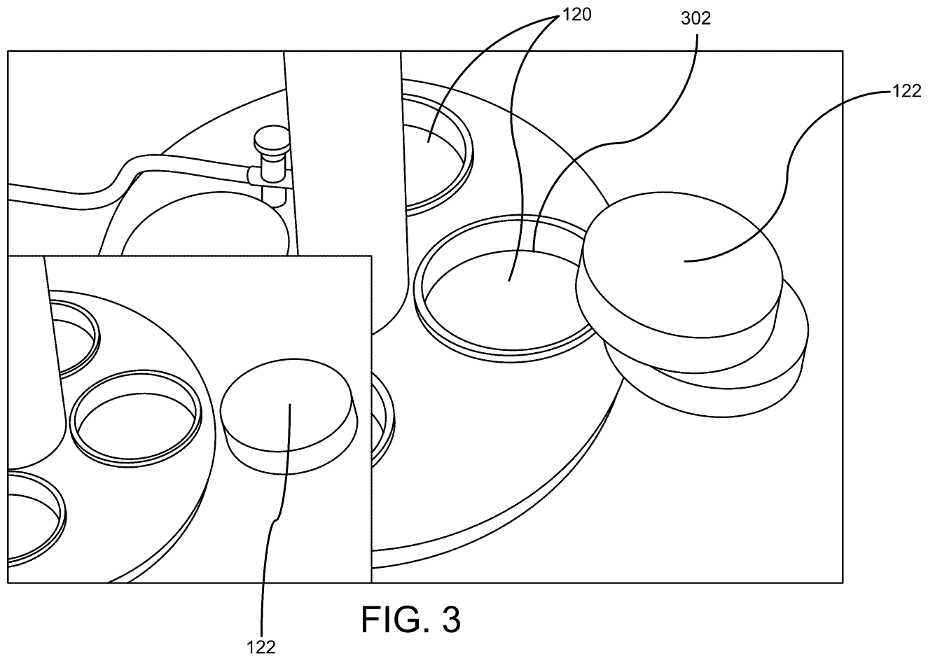

FIG. 3 illustrates an enlarged view of the disc molds 120 used in the plastic recycling system of the present invention for forming recycled discs in accordance with the disclosed structure. Each disc mold 120 is used for solidifying the molten plastic (burned by the burner 206 at the bottom of the cylinder 102). Each mold 120 is disc shaped and the molten plastic is poured into the disc-shaped molds 120 and is evenly distributed with minimum air bubbles. The walls 302 of each mold are maintained at a cold temperature for cooling the molten plastic. The cold plastic takes the shape of the disc-shaped mold 120 and the discs 122 can be manually or automatically ejected from the molds 120. It will be apparent to a person skilled in the art that the mold material, the mold design, and the cooling rate can vary depending on the plastic and the design of the recycled product.

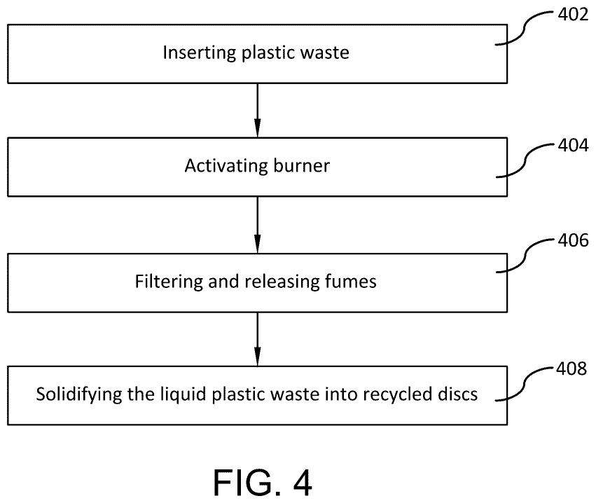

FIG. 4 illustrates a flow chart depicting the recycling process of plastic waste using the plastic recycling furnace device of the present invention in accordance with the disclosed architecture. Initially, plastic waste in the form of solid blocks pre compressed by compactor for either residential or commercial use of different sizes are inserted through the trap door 106 for burning and recycling (Step 402). Then, the burner 206 is activated by a user and controlled by the control knob for burning and melting the inserted plastic waste (step 404).

Upon burning, the fumes along the steel cylinder are filtered using carbon filters and are released from the heat-safe extension cap 114 (Step 406). Finally, the molten plastic then flows into the disc molds 120 and is converted into a series of the recycled discs (Step 408).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “polymer processor”, “polymer burning furnace system”, “plastic burning furnace system”, “plastic recycling system”, and “system” are interchangeable and refer to the plastic recycling furnace device 100 of the present invention.

Notwithstanding the forgoing, the plastic recycling furnace device 100 of the present invention can be of any suitable size and configuration as is known in the art without affecting the overall concept of the invention, provided that it accomplishes the above stated objectives. One of ordinary skill in the art will appreciate that the plastic recycling furnace device 100 as shown in the FIGS. 1-3 are for illustrative purposes only, and that residential or commercial of the plastic recycling furnace device 100 are well within the scope of the present disclosure. Although the dimensions of the plastic recycling furnace device 100 are important design parameters for user convenience, the plastic recycling furnace device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plastic burning furnace system comprising:
a stainless steel cylinder, a burner, a base, a plurality of disc molds, and a structure of supporting members;
wherein said cylinder mounted on said base and supported with said plurality of supporting members;
wherein said cylinder having a door proximal to a lower end for enabling a user to insert plastic into said cylinder for recycling and a heat-safe extension cap positioned at a top end of said cylinder for dissipating smoke emitting from said cylinder; a set of tubes for moisture extraction near cap;
wherein said burner positioned at a bottom end of said cylinder for melting said plastic; and
further wherein the melted said plastic flows into said set of disc molds for recycling the plastic into discs that are formed in said set of disc molds.

2. The burning furnace of claim 1, wherein said cylinder having a smoke meter, and further wherein said smoke meter monitors a smoke level inside said cylinder for detecting a pressure of the smoke inside said cylinder.

3. The burning furnace of claim 2, wherein said smoke detector having an analog meter for detecting and displaying a pressure of the smoke inside said cylinder.

4. The burning furnace of claim 3, wherein said cylinder is upright.

5. The burning furnace of claim 4, wherein said door having a handle for locking and unlocking said door to said cylinder.

6. The burning furnace of claim 5, wherein said supporting members are anchored to the ground.

7. The burning furnace of claim 6, wherein said plastic burning furnace having a protective boundary surrounding said plastic burning furnace for prohibiting contact with high temperatures.

8. A plastic burning furnace system comprising:
a stainless steel cylinder, a burner, a base, a series of disc molds, and a series of supporting members;
wherein said cylinder mounted on said base and supported with said structure of supporting members;
wherein said cylinder having a door proximal to a lower end for enabling a user to insert plastic into said cylinder for recycling and a heat-safe extension cap positioned at a top end of said cylinder for dissipating smoke emitting from said cylinder;
wherein said cylinder having a set of carbon filters positioned inside said cylinder for absorbing volatile organic compounds (VOCs) from fumes passing through said cylinder;
wherein each of said plurality of carbon filters having a ceramic shroud therearound for providing thermal insulation to said series of carbon filters;
wherein said burner positioned at a bottom end of said cylinder for melting said plastic; and
further wherein the melted said plastic flows into said series of disc molds for recycling the plastic into discs that are formed in said set of disc molds.

9. The burning furnace of claim 8, wherein said cylinder having a smoke meter, and further wherein said smoke meter monitors a smoke level inside said cylinder for detecting a pressure of the smoke inside said cylinder.

10. The burning furnace of claim 9, wherein said smoke detector having an analog meter for detecting and displaying a pressure of the smoke inside said cylinder.

11. The burning furnace of claim 10, wherein said cylinder is upright.

12. The burning furnace of claim 11, wherein said door having a handle for locking and unlocking said door to said cylinder.

13. The burning furnace of claim 12, wherein said supporting members are anchored to the ground.

14. The burning furnace of claim 13, wherein said plastic burning furnace having a protective boundary surrounding said plastic burning furnace for prohibiting contact with high temperatures.

15. A method of recycling plastic in a plastic burning furnace, the method comprising the following steps of:
providing a plastic burning furnace having a stainless steel cylinder, a burner, a base, and a set of disc molds, wherein said burner positioned at a bottom end of said cylinder;
mounting said cylinder to said base, wherein said cylinder having a door proximal to a lower end for enabling a user to insert plastic into said cylinder for recycling and a heat-safe extension cap positioned at a top end of said cylinder for dissipating smoke emitting from said cylinder, further wherein said cylinder having a set of carbon filters positioned inside said cylinder for absorbing volatile organic compounds (VOCs) from fumes passing through said cylinder;
inserting said plastic into said cylinder;
melting said plastic in said cylinder;
flowing the melted said plastic into said plurality of disc molds; and
forming the melted said plastic into discs.

16. The method of recycling plastic of claim 15, wherein said cylinder having a smoke meter, and further wherein said smoke meter monitors a smoke level inside said cylinder for detecting a pressure of the smoke inside said cylinder.

17. The method of recycling plastic of claim 16, wherein said smoke detector having an analog meter for detecting and displaying a pressure of the smoke inside said cylinder.

18. The method of recycling plastic of claim 17, wherein each of said plurality of carbon filters having a ceramic shroud therearound for providing thermal insulation to said set of carbon filters.

19. The method of recycling plastic of claim 18, wherein said cylinder is upright.

20. The method of recycling plastic of claim 19, wherein said plastic burning furnace having a protective boundary surrounding said plastic burning furnace for prohibiting contact with high temperatures.
